(19) United States
(12) Patent Application Publication
(10) Pub. No.: US 2025/0142268 A1
(43) Pub. Date: May 1, 2025

(54) HEARING DEVICE WITH FACEPLATE-MOUNTED ANTENNA

(71) Applicant: Sonova AG, Stäfa (CH)

(72) Inventors: John Whitmore, Stäfa (CH); MunSoo Bae, Stäfa (CH)

(21) Appl. No.: 18/498,666

(22) Filed: Oct. 31, 2023

(51) Int. Cl. H04R 25/00; H01Q 1/27

(52) U.S. Cl. CPC H04R 25/609; H01Q 1/273; H04R 25/554; H04R 25/602; H04R 25/652; H04R 2225/31; H04R 2225/51

(57) ABSTRACT

A hearing device including a housing shell housing an electronics package of electronic components and having an antenna mount that supports and/or encloses an antenna protruding from the housing shell. The housing shell may further include an earpiece that is configured to be inserted into an ear canal of a user, which protrudes in a substantially opposite direction of the antenna mount. The antenna mount can be a rounded fin-shape.

### BACKGROUND

Modern hearing devices are electronic instruments worn in or around the ear canal that compensate for hearing loss or hearing impairment by receiving, amplifying, and reproducing sound waves. These are complex electronic devices that can often contain many electronic parts. For example, a single hearing device typically contains an antenna, a printed circuit board (PCB), a battery, and a speaker, among others. Despite containing a high number of electronic parts, these hearing devices are typically designed to be as compact as possible. Common hearing aid structures include in-the-ear (ITE) where part of the device fits in the ear canal and part is exposed, and completely-in-canal (CiC) where the entire device is fit within the ear canal.

With such physical manufacturing constraints, it is easy to imagine the number of challenges that can arise in the design of these devices. People who wear hearing aids often do not want the device to be visible, and thus the aesthetic presentation of the device is a significant design consideration. The insertion into and out of the ear canal can become difficult if there is not a handle for the user to grip. The parts of the hearing device can be fragile if there is not a sturdy layer of protection. Finally, the dielectric characteristics of the ear itself can block and interfere with the antenna, and result in a loss of radiating efficiency. Given these numerous problems, there is a need for a hearing device that balances these individual considerations into an improved integrated design.

### BRIEF SUMMARY

As shown throughout the embodiments of this disclosure, an improved hearing device is presented that addresses these problems.

According to an embodiment of the hearing device, the hearing device comprises a housing shell comprising a fitted portion configured to fit inside an ear canal of a user and a faceplate; an antenna mount protruding from the faceplate; and an antenna protruding from the faceplate and embedded in the antenna mount; wherein the antenna mount is a solid structure having a face and a perimeter, the face having a surface area greater than a surface area of the perimeter.

In various embodiments of the above, the hearing device can have a sell configured to fit at least partially inside the ear canal and a faceplate, an antenna mount protruding from the faceplate, and an antenna protruding from the faceplate and mounted to the antenna mount, wherein the antenna mount is a fin-like structure having a face and a perimeter, the face having a surface area greater than a surface area of the perimeter; the antenna mount may be made of a transparent or translucent plastic material, or a material having a substantially same color as a color of the faceplate; the faceplate may have a curved surface and the antenna mount may extend seamlessly from the curved surface; the antenna mount may be substantially triangular or substantially rectangular; the antenna mount may comprise a rounded edge; the antenna mount may comprise a soft material; the antenna may be a patch-type antenna or a dipole antenna; the faceplate antenna mount may be a single 3D-printed piece; a method for producing the hearing device may comprise 3D printing the single piece; a surface area of the antenna mount inside the antenna may be greater than a surface area of the antenna mount outside the antenna; the antenna may be longer than the perimeter of the mount; the antenna may be a solid shape; the hearing device may comprise a power circuit in the housing, the power circuit having charging contact pins or a charging coil; the hearing device may comprise a wireless transceiver connected to the antenna; the housing may comprise an internal slot configured to receive a protruding portion of the antenna; the hearing device may further comprise a contact pin or a charging coil mounted at a side wall or a face of the antenna mount; the hearing device may further comprise an additional contact pin or an additional charging coil mounted at an opposite side wall or an opposite face of the antenna mount.

In various embodiments of the hearing device, a method for producing the hearing device may comprise 3D printing the hearing device as a single molded piece.

### BRIEF DESCRIPTIONS OF THE SEVERAL VIEWS OF THE DRAWINGS

FIG. 1 illustrates an example antenna mount and electronics package.

FIG. 2 is an isometric view of an example antenna mount.

FIG. 3A is a front view of an example of an assembled hearing device according to the present disclosure.

FIG. 3B is a side view of an example of an assembled hearing device according to the present disclosure.

FIG. 4 illustrates an example of an assembled hearing device according to the present disclosure, positioned within a user's ear.

FIG. 5 illustrates a block diagram of an example system for a hearing device according to the present disclosure.

FIG. 6 is an example antenna and mount according to the present disclosure.

FIG. 7 is an example of an assembled hearing device according to the present disclosure.

FIG. 8 illustrates an example of an antenna on a perimeter edge of an antenna mount.

FIGS. 9A-9B show an example of an assembled hearing device, where the faceplate is removed from the housing.

FIGS. 10A-10C show various embodiments of charging contacts on an antenna mount of the assembled hearing device.

### DETAILED DESCRIPTIONS OF THE DRAWINGS

Considering the above, there is a need for a hearing device that offers improved signal reception while being easily removable and maintaining an aesthetically pleasing design. The present disclosure accordingly describes a hearing device that accomplishes this by providing an antenna that protrudes from a contoured faceplate, and is affixed to the face of a fin-shaped mount. The fin-shaped mount design makes for efficient use of surface area, by allowing the antenna to extend farther from the surface of the hearing device and reduce signal interference caused by the user's ear while minimizing the overall surface area footprint it occupies on the faceplate of the hearing device. The fin-shaped mount also protects the antenna, and additionally provides a grip for a user to easily remove the hearing device from the user's ear canal. Further advantages of the present hearing device will become apparent throughout the disclosure.

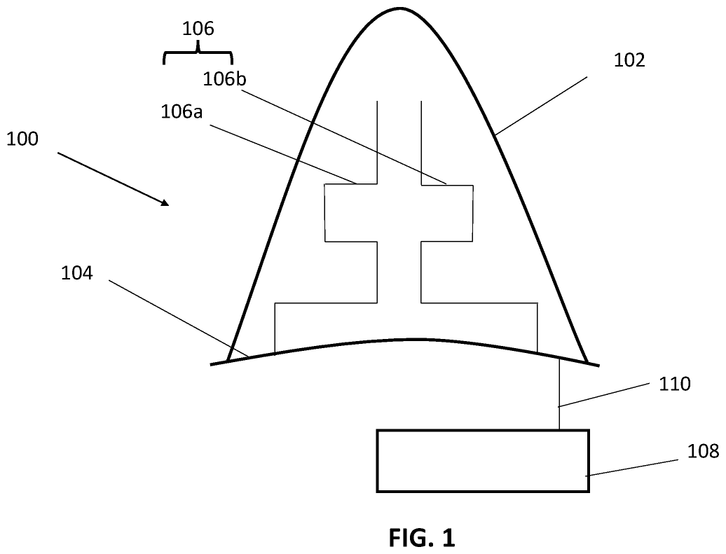

FIG. 1 shows a simple structural illustration of an antenna mount assembly 100. As shown, an antenna mount 102 protrudes upward from a faceplate surface 104. An embodiment of the antenna mount 102, as shown in FIG. 1, has a “fin-like” design, which can be a triangular shape with a rounded tip, a substantially rectangular shape with a narrower protruding end and rounded edges, or more generally a protruding shape that becomes narrower farther from its base. This shape allows for an efficient use of space, as an antenna may be wider near its bottom edge and protrude outward to a narrower tip, thereby maximizing the distance the antenna can protrude out from the faceplate 104 while occupying less surface area at the faceplate 104. The antenna mount 102 can be molded in a various alternative shapes to accompany the structure of the antenna. At its bottom surface, the antenna mount 102 is attached to the faceplate 104.

A fin-shaped antenna mount may have the following dimensions, for example: a width at the base of the antenna mount 102 can be between 5 mm and 8 mm, a height of the antenna mount 102 can be between 7 mm and 9 mm, an area of a surface of a face of the antenna mount 102 can be between 17.5 mm² and 36 mm², and a perimeter (including the width of the base) of the antenna mount 102 can be between 17.4 mm and 24 mm. It should be understood that these dimensions are approximations that can vary based on antenna mount design. It is contemplated that additional embodiments may employ dimensions outside of the above ranges.

The attachment between the antenna mount 102 and faceplate 104 may be made in a variety of ways, e.g., bonding, molding, removable attachment via fasteners, or the two can instead be manufactured as a single piece. The antenna mount may also be detachably fixed to the faceplate 104. The faceplate may be rounded, curved or contoured, as shown in FIG. 1, or it alternatively may be flat. A rounded, curved or contoured surface as shown provides a good attachment between the antenna mount 102 and the faceplate 104. Additionally, this shape provides an additional benefit of pushing the antenna upward from the faceplate 104, allowing for clearance from the ear and good signal reception. The bottom of antenna mount 102 should further match the shape of the faceplate 104.

An external antenna 106 is mounted to the fin 102 and in some embodiments, for example in FIG. 1, the antenna is a dipole antenna having a left antenna element 106a and a right antenna element 106b. In a dipole antenna, the left antenna element 106a and the right antenna element 106b may be understood as dipole arms. The external antenna 106 may alternatively be a monopole, patch, or loop antenna, along with other antenna types known in the art. Further, the external antenna 106 may be formed onto the surface of the antenna mount 102 via laser direct structuring (LDS). While the external antenna 106 may employ different specific configurations, an antenna design that converges near the top of the antenna mount will offer the most efficient use of space while maintaining high quality signal reception.

The external antenna 106 may be mounted inside the antenna mount 102, such that the antenna mount 102 protects the external antenna 106 from damage, particularly when a user grips the antenna mount 102 to remove the device from the user's ear canal. Mounting the external antenna 106 inside the antenna mount 102 advantageously protects the external antenna 106 from being touched or contacted.

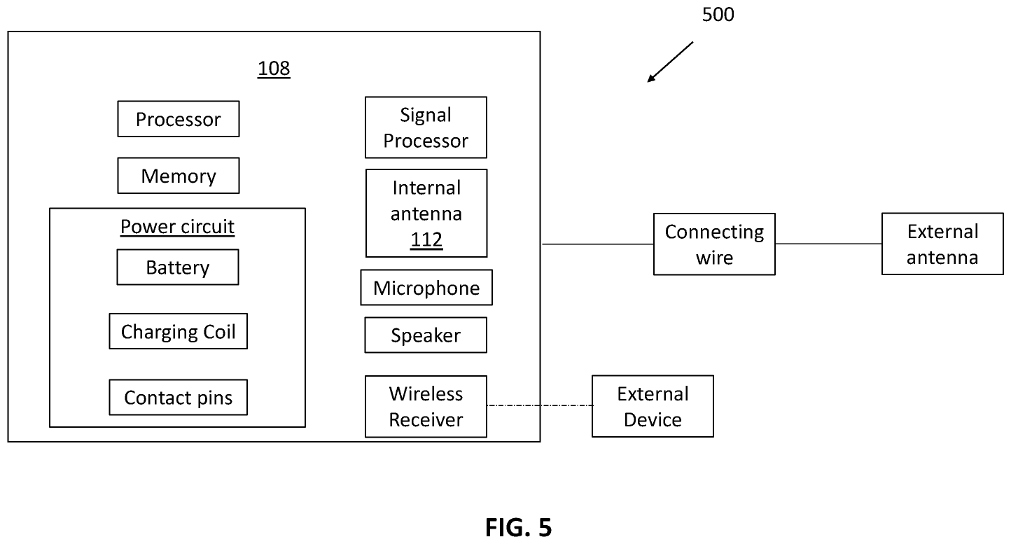

The antenna mount assembly 100 further includes an electronics package 108 contained beneath the faceplate 104 and connected to the external antenna 106 via a wire 110. The electronics package may be a system-in-package having multiple integrated circuits, disposed on PCBs, enclosed in a chip package, or it may formed as a single integrated chip. Other package structures may be viable for enclosing the electronics. Further, while wire 110 is illustrated as a single wire, there may be additional wires such that each of the right antenna element 106a and left antenna element 106b are connected via corresponding individual wires. A detailed system illustration of the components of the electronics package 108 is shown in FIG. 5.

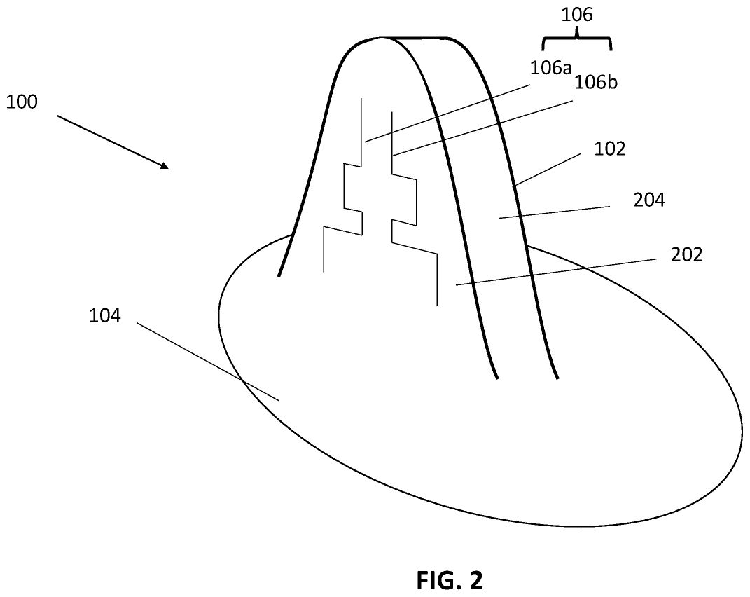

FIG. 2 shows isometric view of the antenna mount 102 and the faceplate 104. The antenna mount 102 has face 202 and an edge 204. The face 202 of the antenna mount 102 takes the geometric shape of the mount, e.g., a rounded triangle, a rounded rectangle, etc., whereas the edge 204 of the antenna mount 102 provides a width to a perimeter of the antenna mount 102. The external antenna 106 can be longer than the edge 204. As shown in FIG. 2, the external antenna 106 can be mounted to the antenna mount. For example, the antenna 106 can be mounted on or embedded inside the face 202, such that the face 202 has a surface area greater than the surface area occupied by the antenna. It will also be appreciated that the face 202 may have a surface area greater than a surface area of the edge 204.

One such geometric shape of the antenna mount 102 may be an arch, as shown in FIG. 2. An arch in the various embodiments can, for example, be a triangular shape or a triangle with a rounded tip and a curved transition to the surface of the faceplate. The antenna mount 102 may also be solid, as shown in FIG. 2, in that the mount is a solid geometric shape. In FIG. 2, the arch is a solid arch in that a solid material makes up the area from the faceplate 104 to the edge 204. Additionally, in embodiments of the hearing device with a dipole antenna, there is a surface area between the left antenna element 106a and the right antenna element 106b that is understood as an area inside the antenna. The remainder of the surface area of the face 202 of the antenna mount 102 is thus an area outside the antenna. In some embodiments, the surface area inside the antenna is greater than the surface area outside the antenna.

As seen from this angle, the antenna mount 102 has a thickness sufficient to fully enclose and protect the external antenna 106 when it is mounted inside of the antenna mount 102. The antenna mount 102 further has a thickness to protect a multiple-layer antenna. The material composing the antenna mount 102 may advantageously be a soft plastic that is lightweight with a low dielectric constant (low DK). The soft texture makes the antenna mount 102 easy for the user to grasp and remove the device from the user's ear. The antenna mount may also be flexible. Additionally, the antenna mount may be made of a transparent material, which provides at least an aesthetic benefit of reducing the visibility of the device. As an example, a transparent Silicon or Silicone may be used as the material for the antenna mount 102. It is contemplated that other plastics and transparent materials may alternatively be used. Translucent or opaque materials may also be used. The shape of the antenna mount 102 is advantageous over removal lines or pull-cords that are common in hearing devices because these removal lines and pull-cords are less sturdy, require additional pieces, are aesthetically unwanted, and can result in contact between the removal line and the ear canal of the user.

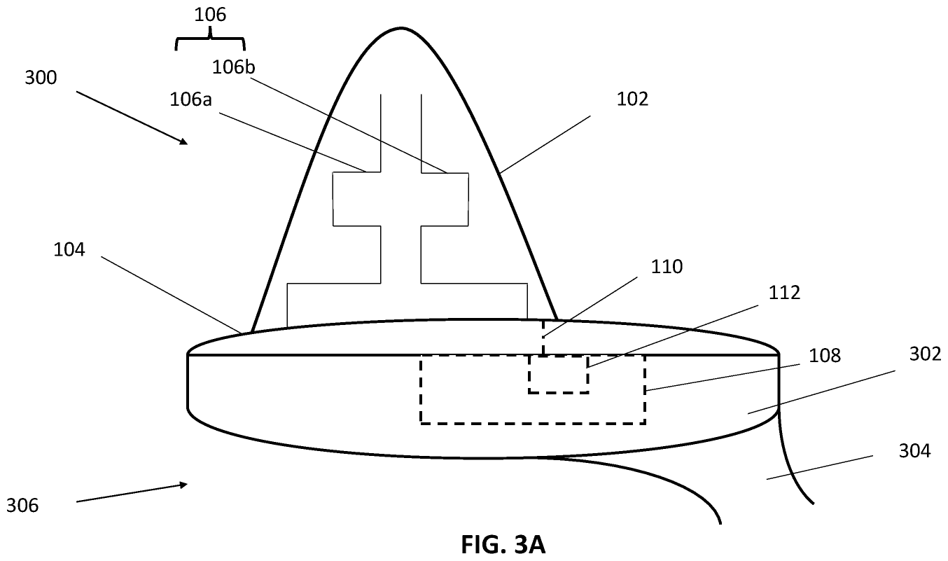

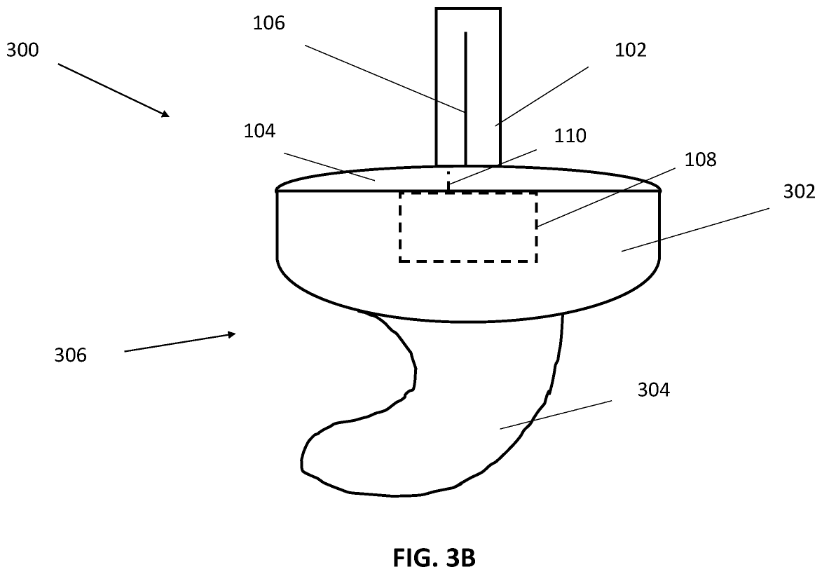

FIGS. 3A and 3B show various views of an assembled hearing device according to the present disclosure. Beginning with FIG. 3A, a front of view of an assembled hearing device 300 is shown. The embodiment shown in FIG. 3A and shown throughout the other drawings is an ITE hearing device where a portion of the hearing device is designed to be inserted in a user's ear and another portion is designed to be exposed (i.e. the antenna mount assembly 100). The faceplate 104 is shown as attached to a top surface of a housing 302. Alternatively, the faceplate 104 may be integrally formed with the housing 302. The housing 302 may have a similarly rounded bottom as the faceplate 104, as this provides a more comfortable fit when inserted into the ear of a user. Further, the housing 302 should have a width approximately matching a width of the user's ear canal to ensure a proper fit. This can be accomplished by producing the housing 302 in different sizes or producing a custom housing particular to the user's ear shape. The faceplate 104, the housing shell 302 and the earpiece 304 may collectively form a housing 306.

The external antenna 106 is at least partially external to the housing and protrudes from the faceplate 104. The external antenna 106 may be further connected to an internal antenna 112 via the wire 110. The internal antenna 112 and external antenna 106 can be a single antenna having an internal part and an external part.

The electronics package 108 is shown embedded in the housing 302, preferably hidden from view from the exterior of the housing 302. Additionally, the wire 110 extends downward through the faceplate to connect the external antenna 106 to the electronics package 108. For ensuring a secure fit into the user's ear, an earpiece 304 may extend downward from the housing shell 302 and away from the antenna mount 102. The earpiece 304 may further be contoured fit the shape of the user's ear canal, as illustrated more clearly in FIG. 3B.

FIG. 3B illustrates a side view of the assembled hearing device. The earpiece 304 is a protruding member that is substantially rounded along all of its edges and shaped to hook into the user's ear canal for a secure fit. The earpiece 304 may be a soft, flexible material, such as plastic, rubber, foam and the like. As also seen from this angle, the external antenna 106 is positioned near the middle of the antenna mount, but in some embodiments it may be advantageous to position the external antenna 106 closer to one of the edges to improve signal quality.

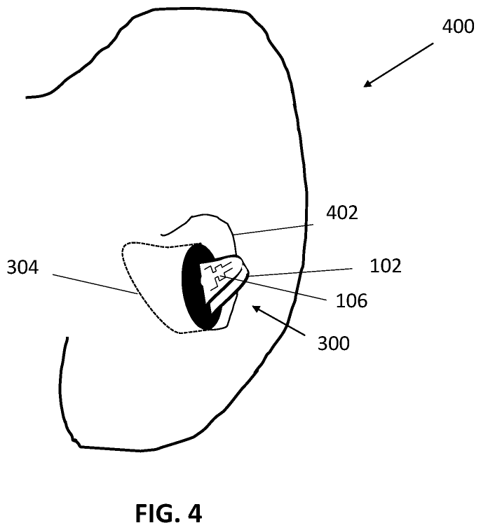

FIG. 4 shows a user's ear 400, and the assembled hearing device 300 inserted within the ear canal 402 of the ear 400. As seen in the figure, the antenna mount 102 of the assembled hearing device 300 protrudes out from the entrance of the ear canal 402. This configuration provides at least the benefit of providing separation between the external antenna 106 and the inside of the user's ear canal 402. As the ear is a natural dielectric material, it provides unwanted interference with signals received by the external antenna 106. Thus, increasing the distance the antenna protrudes from the user's ear canal 402 improves the performance of the hearing device.

Other factors that may influence the size and shape of the hearing device are comfort, aesthetics, and ease of removing the device. Accordingly, the protruding antenna mount 102 provides an additional benefit of providing a grip for the user to easily remove the hearing device from the ear canal. The removal aspect of the antenna mount 102 can additionally be improved by adding detail to the shape of the antenna mount 102, such as providing grooves, indents, textures and the like.

FIG. 5 is a block diagram of a system of components 500 in or connected to the housing for the hearing device according to the present embodiment. The system 500 includes an electronics package 108, which can have internal circuits and computing devices such as, but not limited to a processor that controls the operation of the hearing device, a memory, a wireless receiver (that receives wireless signals) or transceiver (that transmits and receives wireless signals), a microphone, a speaker (sometimes known as a “receiver”), a power circuit that manages the power stored and supplied to the device, a signal processor connected to the microphone, wireless receiver and/or speaker, an internal antenna 112 and the like. Additionally, multiple wireless receivers that receive different types of frequencies can be provided. The electronics package 108 is connected via a connecting wire or wires to the external antenna 106.

Additionally, the hearing device can receive signals from and be controlled by an external device, via the wireless receiver or transceiver. The signals may be Bluetooth, radio frequency, etc. or any other types used in wireless communications. The external device can be a number of different devices such as a dedicated controller for the hearing device, a smartphone or the like. If this is implemented, different functions can be controlled such as powering on, powering off, adjusting volume, etc.

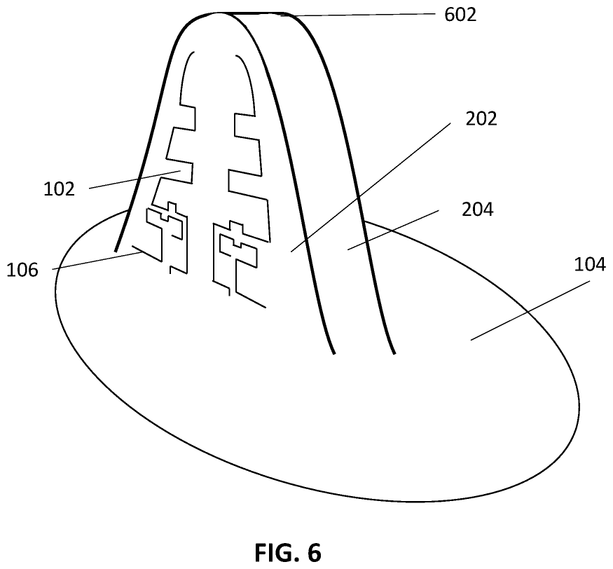

FIG. 6 shows an example of an antenna mount assembly of a hearing device according to the present disclosure. The antenna mount 102 in this case is triangular with a rounded tip 602. The triangular antenna mount 102 further features a height from the faceplate to the tip 602 that is longer than the width of its base, which advantageously maximizes the clearance between the external antenna 106 and the faceplate 104. In this embodiment, each of the left antenna element 106a and right antenna element 106b are connected to the electronics package 108 (not shown) via its own dedicated connecting wire or wires 110. It is further shown that the antenna mount can accommodate a more complicated pattern than what is shown in the illustrations of FIGS. 1-3. The external antenna 106 can further be a single-layer or multilayer antenna. The external antenna 106 can additionally be or include an end-fire antenna, such as a Yagi antenna. While the antenna 106 may be formed near the face 202 of the antenna mount 102, the antenna 106 can still be protected from contact by the face 202 or by a protective coating.

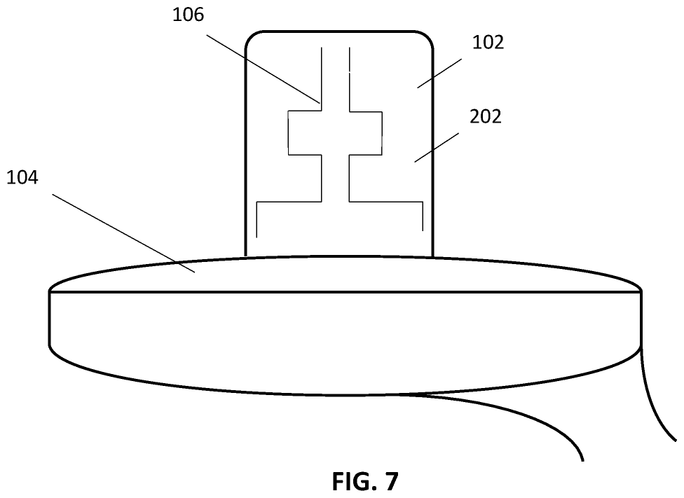

FIG. 7 shows another example of a hearing device according to the present disclosure. In this alternative embodiment, the antenna mount 102 is instead a parabolic shape where substantially the entire edge is rounded. This design better accommodates the rectangular shape of a monopole or patch antenna as shown, while still achieving the functional and aesthetic advantages of the embodiment in FIG. 6. The antenna may be, for example, a single Hilbert meandering antenna as shown in FIG. 6.

In both embodiments, the antenna mount 102 is a substantially transparent or translucent material such that the embedded antenna is visible from the outside. It should be further appreciated that the thin, protruding shapes in FIGS. 6 and 7 provide a grip for a user to easily remove the hearing device from the user's ear canal.

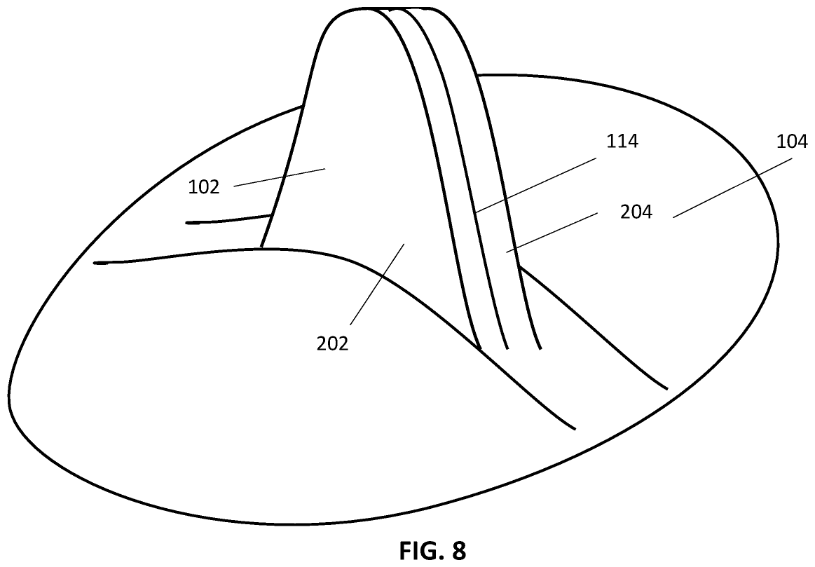

FIG. 8 shows a wire antenna 114 at the perimeter edge 204 of a fin-shaped antenna mount 102. The wire antenna 114 can be located around the outline or near the perimeter edge 204 of the antenna mount 102. A monopole or dipole antenna can be shaped around the outline of the antenna mount and a patch antenna may be formed on the face 202 of the antenna mount 102. The wire antenna 114 may alternatively be an LDS-formed antenna.

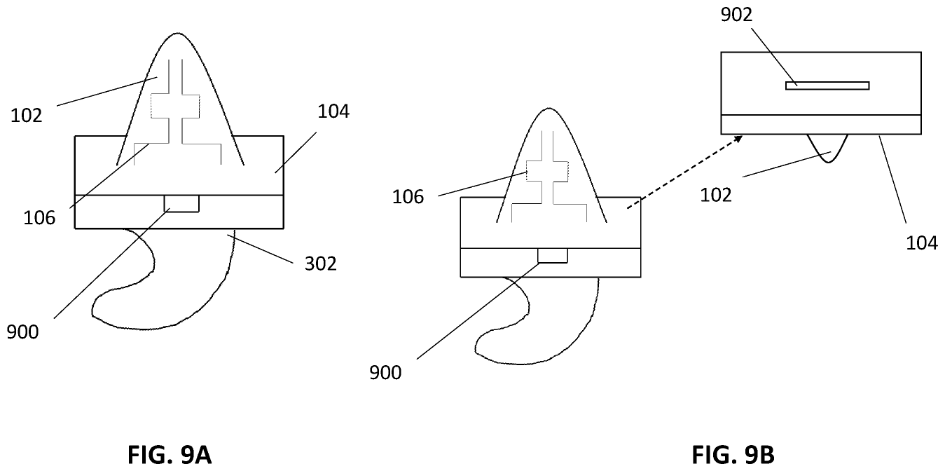

FIGS. 9A and 9B show assembled and disassembled views of the hearing device, respectively. FIG. 9A shows the assembled embodiment with the faceplate 104 bonded to the housing 302. As shown in FIG. 9A, the faceplate 104 contains a location for a charging contact 900, such as a contact pin or charging coil. FIG. 9B shows a disassembled view where the faceplate 104 and housing 302 are shown separately. In FIG. 9B, the faceplate 104 is shown upside-down so that an underside of the faceplate 104 is visible. A slot 902 is built into the faceplate 104, revealing a hollow structure of the antenna mount 102. The hollow structure of the antenna mount 102 can allow for a protruding portion of the antenna 106 to be accepted by the antenna mount 102 through the slot 902. The protruding portion may be a vertical flex antenna.

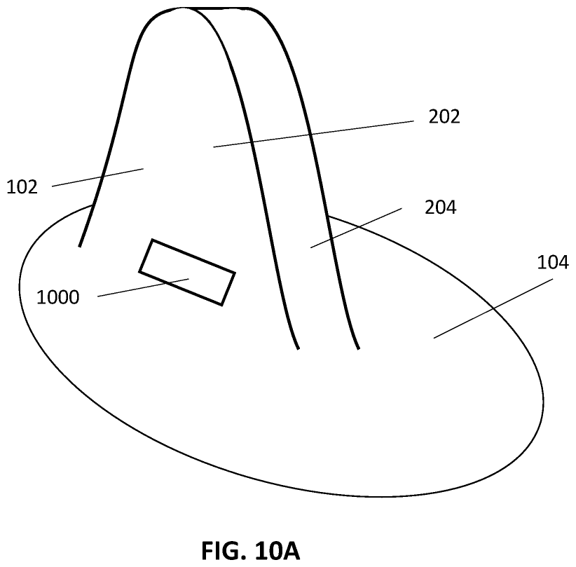

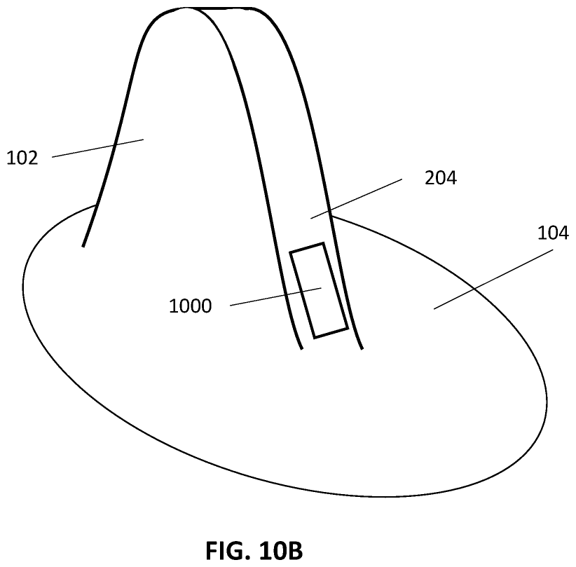

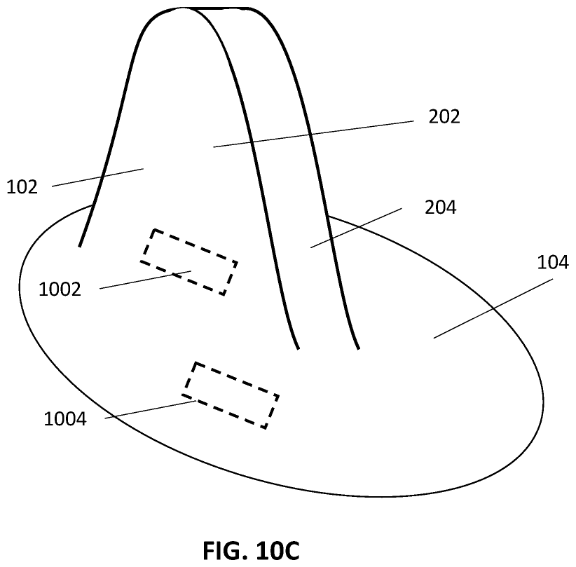

The power circuit includes a battery, which may be rechargeable by way of, for example, charging contact pins or charging coils. The contact pins may be disposed on the surface of the antenna mount. FIGS. 10A-10C show various embodiments of a charging contact on the antenna mount 102. In FIG. 10A, the charging contact is a contact pin 1000 disposed on the face 202 of the antenna mount 102, near the faceplate 104. In FIG. 10B, the contact pin 1000 is disposed on the edge 204 of the antenna mount 102. Two contacts (for example, positive and negative contacts) can be located on a same face or edge. Alternatively, one of the two contacts can be located as shown in FIGS. 10A and 10B and another of the contacts can be located on a face hidden from view in FIG. 10A or an opposite edge hidden from view in FIG. 10B. Additionally or alternatively, the antenna mount 102 can have an embedded charging coil which can be adapted for wireless charging. FIG. 10C shows a charging coil 1002, disposed underneath the surface of the antenna mount 102. With an embedded charging coil, the antenna mount may also include a magnet for retention of a charger. In embodiments where the antenna mount 102 implements either contact pins or a charging coil, the hearing device may be configured to pair with a slot that accepts the antenna mount 102 and performs charging by either contact or wireless charging.

It is also contemplated that certain manufacturing techniques, such as 3D printing, may be implemented to produce the components of the hearing device of the embodiments herein. Further, it should be understood that it is possible to 3D print interlocking parts, such as the faceplate/antenna mount and the housing shell, that can be bonded in a final assembly, or alternatively to 3D print the entire structure as a single 3D-printed piece. While various features are presented above, it should be understood that the features may be used singly or in any combination thereof. Further, it should be understood that variations and modifications may occur to those skilled in the art to which the claimed examples pertain.

1. A hearing device comprising:
a housing comprising a shell configured to fit at least partially inside the ear canal and a faceplate;
an antenna mount protruding from the faceplate; and
an antenna protruding from the faceplate and mounted at the antenna mount,
wherein the antenna mount is a fin-like structure having a face and a perimeter, the face having a surface area greater than a surface area of the perimeter.

2. The hearing device of claim 1, wherein the antenna mount is made of a transparent or translucent plastic material, or a material having a substantially same color as a color of the faceplate.

3. The hearing device of claim 1, wherein the faceplate has a curved surface and the antenna mount extends seamlessly from the curved surface.

4. The hearing device of claim 1, wherein the antenna mount is substantially triangular or substantially rectangular.

5. The hearing device of claim 4, wherein the antenna mount comprises a rounded edge.

6. The hearing device of claim 1, wherein the antenna mount comprises a soft material.

7. The hearing device of claim 1, wherein the antenna is a patch-type antenna or a dipole antenna.

8. The hearing device of claim 1, wherein the faceplate and the antenna mount are a single 3D-printed piece.

9. A method for producing the hearing device of claim 8, the method comprising 3D printing the single piece.

10. The hearing device of claim 1, wherein a surface area of the antenna mount inside the antenna is greater than a surface area of the antenna mount outside the antenna.

11. The hearing device of claim 1, wherein the antenna is longer than the perimeter of the mount.

12. The hearing device of claim 1, wherein the antenna mount is a solid shape.

13. The hearing device of claim 1, further comprising a power circuit in the housing, the power circuit having charging contact pins or a charging coil.

14. The hearing device of claim 1, further comprising a wireless transceiver connected to the antenna.

15. The hearing device of claim 1, wherein the faceplate further comprises an internal slot configured to receive a portion of the antenna protruding from the shell.

16. The hearing device of claim 1, further comprising a contact pin or a charging coil mounted at a side wall or a face of the antenna mount.

17. The hearing device of claim 16, further comprising an additional contact pin mounted at an opposite side wall or an opposite face of the antenna mount.
